(19) United States
(12) Patent Application Publication
(10) Pub. No.: US 2022/0091146 A1
(43) Pub. Date: Mar. 24, 2022

(54) DEVICES AND METHODS FOR FLUID ACTUATION

(71) Applicant: ABBOTT LABORATORIES, ABBOTT PARK, IL (US)

(72) Inventors: Jeffrey B. HUFF, Lincolnshire, IL (US); Mark A. HAYDEN, Vernon Hills, IL (US); Nicholas John COLLIER, Burwell (GB); Stephen BROWN, Hatfield Broad Oak (GB); Karen Xin Zhou YU, Cambridge (GB)

(73) Assignee: ABBOTT LABORATORIES, ABBOTT PARK, IL (US)

(21) Appl. No.: 17/540,974

(22) Filed: Dec. 2, 2021

Related U.S. Application Data
(63) Continuation of application No. PCT/US2020/035941, filed on Jun. 3, 2020.
(60) Provisional application No. 62/856,574, filed on Jun. 3, 2019.

(51) Int. Cl. G01N 35/10; B01L 3/00

(52) U.S. Cl. CPC G01N 35/1016; B01L 3/50273; B01L 2200/025; B01L 2200/12; B01L 2300/0609; B01L 2400/0427; B01L 2300/0819; B01L 2300/12; B01L 2300/161; B01L 2200/10; B01L 2300/0663

(57) ABSTRACT

Digital microfluidic device includes a first substrate and a second substrate aligned generally parallel to each other with a gap defined therebetween in side view. At least one of the first substrate and the second substrate include a first electrode array, a second electrode array spaced from and in electrical communication with the first electrode array, and a first interstitial area defined between the first electrode array and the second electrode array. At least one of the first electrode array and the second electrode array is configured to generate electrical actuation forces within an actuation area to urge at least one droplet within the gap along the at least one of the first substrate and the second substrate. At least one spacer is disposed in the first interstitial area to maintain the gap between the first substrate and the second substrate.

### CROSS-REFERENCE TO RELATED APPLICATIONS

This application claims the benefit of International Patent Application No. PCT/US2020/035941, filed on Jun. 3, 2020, which claims benefit to U.S. Provisional Patent Application No. 62/856,574, filed on Jun. 3, 2019, which is incorporated by reference herein in its entirety.

### BACKGROUND

### Field of the Disclosed Subject Matter

The disclosed subject matter relates to devices, systems and methods for fluid actuation, for example for reducing or minimizing lid deflection in a digital microfluidic device, which can be used in a digital microfluidic and analyte detection device for performing analyte analysis.

### Description of Related Art

Analytical devices often require manipulation of samples, for example biological fluids, to prepare and analyze discrete volumes of the samples. Digital microfluidics allows for manipulation of discrete volumes of fluids, including electrically moving, mixing, and splitting droplets of fluid disposed in a gap between two surfaces, at least one of the surfaces of which includes an electrode array coated with a hydrophobic and/or a dielectric material. In addition, digital microfluidics allows for accurate and precise yet sensitive analyses using minute samples that can be analyzed quickly and with minimal instrumentation.

Digital microfluidics devices can be included in integrated devices, such as an integrated device for performing analyte analysis. Such devices can be formed by joining opposing substrates spaced apart by a gap. The substrates can be formed using a variety of materials which can have different flexibility characteristics. Using certain substrate materials, such as relatively flexible materials, the substrates can deflect or deform, due at least in part to the weight of the substrates and/or to the surface tension from liquid droplets disposed in the gap. As such, substrates can deflect or deform, for example in areas such as around the center of device and in other areas further away from the edges. Such deflection can affect the accuracy and/or sensitivity of the digital microfluidics device and/or an analyte detection module integrated therewith.

As such, there remains a need for improvement of such devices and systems. Such improvements include, for example, reducing or minimizing deformation or deflection of device components to allow the use of flexible materials for forming such devices.

### SUMMARY

The purpose and advantages of the disclosed subject matter will be set forth in and apparent from the description that follows, as well as will be learned by practice of the disclosed subject matter. Additional advantages of the disclosed subject matter will be realized and attained by the methods and systems particularly pointed out in the written description and claims hereof, as well as from the appended drawings.

To achieve these and other advantages and in accordance with the purpose of the disclosed subject matter, as embodied and broadly described, the disclosed subject matter includes a digital microfluidic device. The device generally includes a first substrate and a second substrate aligned generally parallel to each other with a gap defined therebetween in side view. At least one of the first substrate and the second substrate has a first electrode array, a second electrode array spaced from and in electrical communication with the first array, and a first interstitial area defined between the first electrode array and the second electrode array. At least one of the first electrode array and the second electrode array is configured to generate electrical actuation forces within an actuation area to urge at least one droplet within the gap along the at least one of the first substrate and the second substrate. At least one spacer is disposed in the first interstitial area to maintain the gap between the first substrate and the second substrate.

The first electrode array can be disposed proximate a central region of the at least one of the first substrate and the second substrate and the second electrode array can be disposed proximate a perimeter region of and spaced from the central region of the at least one of the first substrate and the second substrate. The at least one of the first substrate and the second substrate can further include a third electrode array disposed thereon opposite the second electrode array with the first electrode array therebetween and a second interstitial area defined between the first electrode array and the third electrode array, the at least one spacer disposed in the second interstitial area.

The at least one spacer can include a first opening extending therethrough and aligned with the first electrode array in plan view. At least one spacer can include a second opening extending therethrough and aligned with the second electrode array in plan view. At least one of the first substrate and the second substrate can further include a third electrode array disposed thereon, and the at least one spacer includes a third opening extending through a surface thereof and aligned with the third electrode array in plan view.

The first substrate, the second substrate, and the at least one spacer each can include at least one fastener hole aligned to receive a fastener through corresponding fastener apertures of the first substrate, the second substrate and the at least one spacer. The first substrate, the second substrate, and the at least one spacer can each include four fastener apertures each disposed on proximate corresponding corners of the first substrate, the second substrate and the at least one spacer.

The device can further include a frame configured to receive and align the first substrate, the second substrate and the at least one spacer. The frame can have at least one frame fastener hole aligned with at least one of the corresponding fastener apertures, if provided, of the first substrate, the second substrate and the at least one spacer, to receive the fastener through the at least one frame fastener hole.

The at least one spacer can be disposed between the first substrate and the second substrate at a first contact point and a second contact point, the first contact point spaced a distance along the gap from the second contact point by a span. The distance can be within a range of approximately 1 mm to approximately 60 mm. The first substrate can be spaced from the second substrate at the first contact point by a first height, and the first substrate can be spaced from the second substrate at a midpoint of the span by a second height, a difference between the first height and the second height defining a deflection amount, the deflection amount being within a range of approximately 0.05 μm and approximately 180 μm when the at least one droplet is disposed proximate the midpoint.

The at least one of the first substrate and the second substrate can include a non-conductive layer and a conductive layer coupled to the non-conductive layer, the conductive layer having the electrode array defined therein. The at least one of the first substrate and the second substrate can include at least one of a hydrophobic layer and a dielectric layer disposed over the electrode array. The electrode array can be formed on the at least one of the first substrate and the second substrate using at least one of lithography, laser ablation, and inkjet printing. At least one of the first electrode array and the second electrode array can be configured to form external electrical connections. At least one of the first substrate and the second substrate can include at least one of an array of wells and a nanopore layer formed therein.

The spacer can be made from a flexible or non-flexible material. For purpose of example, the spacer can include at least one of PET, PMMA, glass, silicon. As described further herein, the spacer can include adhesive on one side or on both sides. For purpose of example, the spacer can include double-sided tape. As embodied herein, the spacer can have a width between approximately 100 μm and approximately 200 μm. The at least one spacer can include at least one of a shim, a spherical bead, and a raised feature.

At least one of the first substrate or the second substrate can include at least one of PET, PMMA, COP, COC, and PC. As embodied herein, the width of the at least one of the first substrate or the second substrate can be between approximately 100 μm and approximately 500 μm.

In accordance with another aspect of the disclosed subject matter, a method of making a digital microfluidic device is provided. The method includes forming a first electrode array and a second electrode array with a first interstitial area therebetween on at least one of a first substrate and a second substrate, at least one of the first electrode array and the second electrode array configured to generate electrical actuation forces within an actuation area to urge at least one droplet along the at least one of the first substrate and the second substrate within a gap defined between the first and second substrates in side view. The method further includes joining the first substrate and the second substrate proximate opposing sides of at least one spacer to form a chip assembly, the at least one spacer disposed in the first interstitial area to maintain the gap between the first substrate and the second substrate.

In accordance with another aspect of the disclosed subject matter, a digital microfluidic and analyte detection device is provided. The device generally includes a first substrate and a second substrate aligned generally parallel to each other with a gap defined therebetween in side view. At least one of the first substrate and the second substrate has a first electrode array, a second electrode array spaced from and in electrical communication with the first array, and a first interstitial area defined between the first electrode array and the second electrode array. An analyte detection device is defined in at least one of the first substrate and the second substrate, and at least one of the first electrode array and the second electrode array is configured to generate electrical actuation forces within an actuation area to urge at least one droplet within the gap along the at least one of the first substrate and the second substrate to the analyte detection device. At least one spacer is disposed in the first interstitial area to maintain the gap between the first substrate and the second substrate.

It is to be understood that both the foregoing general description and the following detailed description are exemplary and are intended to provide further explanation of the disclosed subject matter claimed.

The accompanying drawings, which are incorporated in and constitute part of this specification, are included to illustrate and provide a further understanding of the disclosed subject matter. Together with the description, the drawings serve to explain the principles of the disclosed subject matter.

### BRIEF DESCRIPTION OF THE DRAWINGS

FIG. 1A is a schematic side view of an exemplary analyte detection module of an integrated digital microfluidic and analyte detection device in accordance with the disclosed subject matter.

FIG. 1B is a schematic side view of another exemplary analyte detection module of an integrated digital microfluidic and analyte detection device in accordance with the disclosed subject matter.

FIG. 2 is a schematic plan view of an exemplary embodiment of an integrated digital microfluidic and analyte detection device in accordance with the disclosed subject matter.

FIG. 3 is an exploded perspective view of an exemplary embodiment of an integrated digital microfluidic and analyte detection device with an exemplary spacer in accordance with the disclosed subject matter.

FIG. 4A is a schematic side view of another exemplary embodiment of an integrated digital microfluidic and analyte detection device with an alternative spacer in accordance with the disclosed subject matter.

FIG. 4B is a schematic side view of another exemplary embodiment of an integrated digital microfluidic and analyte detection device with an alternative spacer in accordance with the disclosed subject matter.

FIG. 4C is a schematic side view of another exemplary embodiment of an integrated digital microfluidic and analyte detection device with an alternative spacer in accordance with the disclosed subject matter.

FIG. 5A is a perspective view of the exemplary device of FIG. 3 being inserted into a frame in accordance with the disclosed subject matter.

FIG. 5B is a perspective view of the exemplary device of FIG. 3 disposed in the frame in accordance with the disclosed subject matter.

FIG. 6 is a diagram illustrating an exemplary technique for forming integrated digital microfluidic and analyte detection devices in accordance with the disclosed subject matter.

### DESCRIPTION

Reference will now be made in detail to the various exemplary embodiments of the disclosed subject matter, exemplary embodiments of which are illustrated in the accompanying drawings. The structure and corresponding method of operation of and method of using the disclosed subject matter will be described in conjunction with the detailed description of the system.

Systems, devices, and methods described herein relate to fluid actuation, including reducing or minimizing lid deflection in a digital microfluidic device, which can be used in a digital microfluidic and analyte detection device for performing analyte analysis. As used interchangeably herein, “digital microfluidics (DMF),” “digital microfluidic module (DMF module),” or “digital microfluidic device (DMF device)” refer to a module or device that utilizes digital or droplet-based microfluidic techniques to provide for manipulation of discrete and small volumes of liquids in the form of droplets. Digital microfluidics uses the principles of emulsion science to create fluid-fluid dispersion into channels (e.g., water-in-oil emulsion), and thus can allow for the production of monodisperse drops or bubbles or with a very low polydispersity. Digital microfluidics is based upon the micromanipulation of discontinuous fluid droplets within a reconfigurable network. Complex instructions can be programmed by combining the basic operations of droplet formation, translocation, splitting, and merging.

Digital microfluidics operates on discrete volumes of fluids that can be manipulated by binary electrical signals. By using discrete unit-volume droplets, a microfluidic operation can be defined as a set of repeated basic operations, e.g., moving one unit of fluid over one unit of distance. Droplets can be formed using surface tension properties of the liquid. Actuation of a droplet is based on the presence of electrostatic forces generated by electrodes placed beneath the bottom surface on which the droplet is located. Different types of electrostatic forces can be used to control the shape and motion of the droplets. One technique that can be used to create the foregoing electrostatic forces is based on dielectrophoresis, which relies on the difference of electrical permittivities between the droplet and surrounding medium and can utilize high-frequency AC electric fields. Another technique that can be used to create the foregoing electrostatic forces is based on electrowetting, which relies on the dependence of surface tension between a liquid droplet present on a surface and the surface on the electric field applied to the surface.

As used herein, “sample,” “test sample,” or “biological sample” refer to a fluid sample containing or suspected of containing an analyte of interest. The sample can be derived from any suitable source. As embodied herein, the sample can comprise a liquid, fluent particulate solid, or fluid suspension of solid particles. As embodied herein, the sample can be processed prior to the analysis described herein. For example, the sample can be separated or purified from a source prior to analysis; however, As embodied herein, an unprocessed sample containing the analyte can be assayed directly. The source of the analyte molecule can be synthetic (e.g., produced in a laboratory), the environment (e.g., air, soil, fluid samples, e.g., water supplies, etc.), an animal (e.g., a mammal, reptile, amphibian or insect), a plant, or any combination thereof. For example and without limitation, as embodied herein, the source of an analyte is a human bodily substance (e.g., bodily fluid, blood, serum, plasma, urine, saliva, sweat, sputum, semen, mucus, lacrimal fluid, lymph fluid, amniotic fluid, interstitial fluid, lung lavage, cerebrospinal fluid, feces, tissue, organ, or the like). Tissues can include, but are not limited to skeletal muscle tissue, liver tissue, lung tissue, kidney tissue, myocardial tissue, brain tissue, bone marrow, cervix tissue, skin, etc. The sample can be a liquid sample or a liquid extract of a solid sample. In certain cases, the source of the sample can be an organ or tissue, such as a biopsy sample, which can be solubilized by tissue disintegration or cell lysis.

As embodied herein, and as described further herein, the integrated digital microfluidic and analyte detection device can have two modules: a sample preparation module and an analyte detection module. As embodied herein, the sample preparation module and the analyte detection module are separate or separate and adjacent. As embodied herein, the sample preparation module and the analyte detection module are co-located, comingled or interdigitated. The sample preparation module can include a plurality of electrodes for moving, merging, diluting, mixing, separating droplets of samples and reagents. The analyte detection module (or “detection module”) can include a well array in which an analyte related signal is detected. As embodied herein, the detection module can also include the plurality of electrodes for moving a droplet of prepared sample to the well array. As embodied herein, the detection module can include a well array in a first substrate (e.g., upper substrate) which is disposed over a second substrate (e.g., lower substrate) separated by a gap. In this manner, the well array is in an upside-down orientation. As embodied herein, the detection module can include a well array in a second substrate (e.g., lower substrate) which is disposed below a first substrate (e.g., upper substrate) separated by a gap. As embodied herein, the first substrate and the second substrate are in a facing arrangement. A droplet can be moved (e.g., by electrical actuation) to the well array using electrode(s) present in the first substrate and/or the second substrate. As embodied herein, the well array including the region in between the wells can be hydrophobic. Alternatively, the plurality of electrodes can be limited to the sample preparation module and a droplet of prepared sample (and/or a droplet of immiscible fluid) can be moved to the detection module using other means.

Droplet-based microfluidics refer to generating and actuating (such as moving, merging, splitting, etc.) liquid droplets via active or passive forces. Examples of active forces include, but are not limited to, electric field. Exemplary active force techniques include electrowetting, dielectrophoresis, opto-electrowetting, electrode-mediated, electric-field mediated, electrostatic actuation, and the like or a combination thereof. For example, and as described further herein, the device can actuate liquid droplets across the upper surface of the first layer (or upper surface of the second layer, when present) in the gap via droplet-based microfluidics, such as, electrowetting or via a combination of electrowetting and continuous fluid flow of the liquid droplets. Alternatively, the device can include micro-channels to deliver liquid droplets from the sample preparation module to the detection module. As a further alternative, the device can rely upon the actuation of liquid droplets across the surface of the hydrophobic layer in the gap via droplet-based microfluidics. Electrowetting can involve changing the wetting properties of a surface by applying an electrical field to the surface and affecting the surface tension between a liquid droplet present on the surface and the surface. Continuous fluid flow can be used to move liquid droplets via an external pressure source, such as an external mechanical pump or integrated mechanical micropumps, or a combination of capillary forces and electrokinetic mechanisms. Examples of passive forces include, but are not limited to, T-junction and flow focusing methods. Other examples of passive forces include use of denser immiscible liquids, such as, heavy oil fluids, which can be coupled to liquid droplets over the surface of the first substrate and displace the liquid droplets across the surface. The denser immiscible liquid can be any liquid that is denser than water and does not mix with water to an appreciable extent. For example, the immiscible liquid can be hydrocarbons, halogenated hydrocarbons, polar oil, non-polar oil, fluorinated oil, chloroform, dichloromethane, tetrahydrofuran, 1-hexanol, etc.

In accordance with an aspect of the disclosed subject matter, a digital microfluidics device is provided. The device generally includes a first substrate and a second substrate aligned generally parallel to each other with a gap defined therebetween in side view. At least one of the first substrate and the second substrate has a first electrode array, a second electrode array spaced from and in electrical communication with the first array, and a first interstitial area defined between the first electrode array and the second electrode array. At least one of the first electrode array and the second electrode array is configured to generate electrical actuation forces within an actuation area to urge at least one droplet within the gap along the at least one of the first substrate and the second substrate. At least one spacer is disposed in the first interstitial area to maintain the gap between the first substrate and the second substrate.

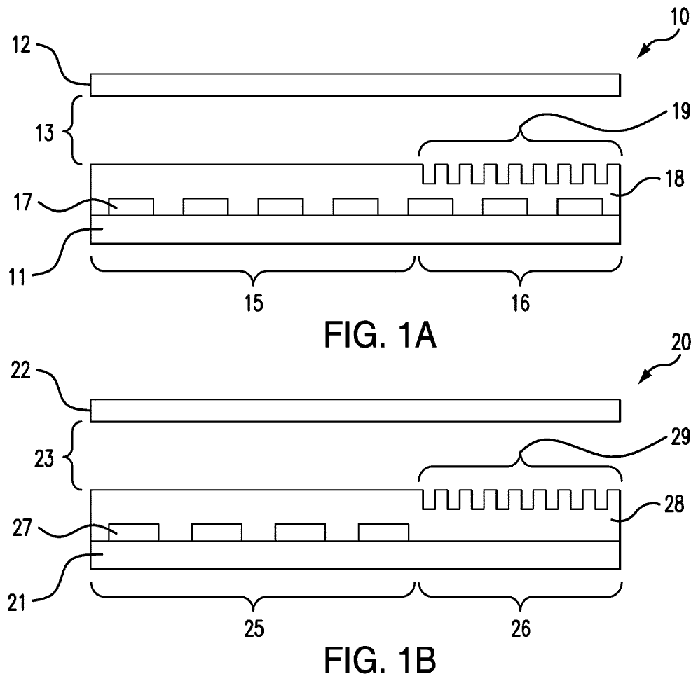

The accompanying figures, where like reference numerals refer to identical or functionally similar elements throughout the separate views, serve to further illustrate various embodiments and to explain various principles and advantages all in accordance with the disclosed subject matter. For purpose of explanation and illustration, and not limitation, exemplary embodiments of the device for fluid actuation, for example for reducing or minimizing lid deflection in a digital microfluidic device, in accordance with the disclosed subject matter are shown in FIGS. 1A-6.

FIG. 1A illustrates an exemplary analyte detection module of an integrated digital microfluidic and analyte detection device 10. The device 10 includes an analyte detection module including a first substrate 11 and a second substrate 12, where the second substrate 12 is aligned generally parallel to the first substrate with a gap 13 therebetween. As embodied herein, the second substrate 12 can be positioned over the first substrate 11, or alternatively, the second substrate 12 can be positioned below the first substrate 11. That is, the terms “first” and “second” are interchangeable and are merely used herein as a point of reference. As illustrated in FIG. 1A, the second substrate 12 can be the same length as the first substrate 11. Alternatively, the first substrate 11 and the second substrate 12 can be of different lengths.

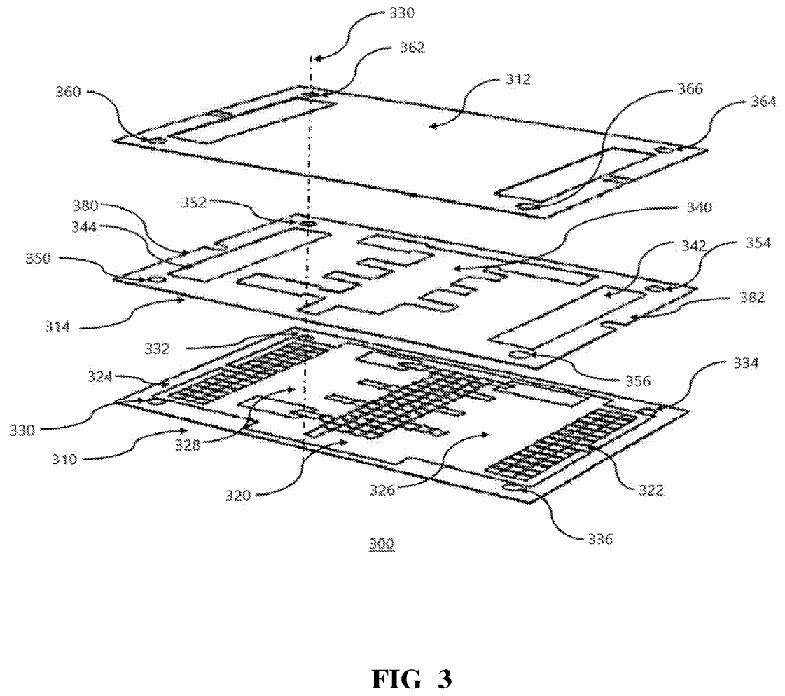

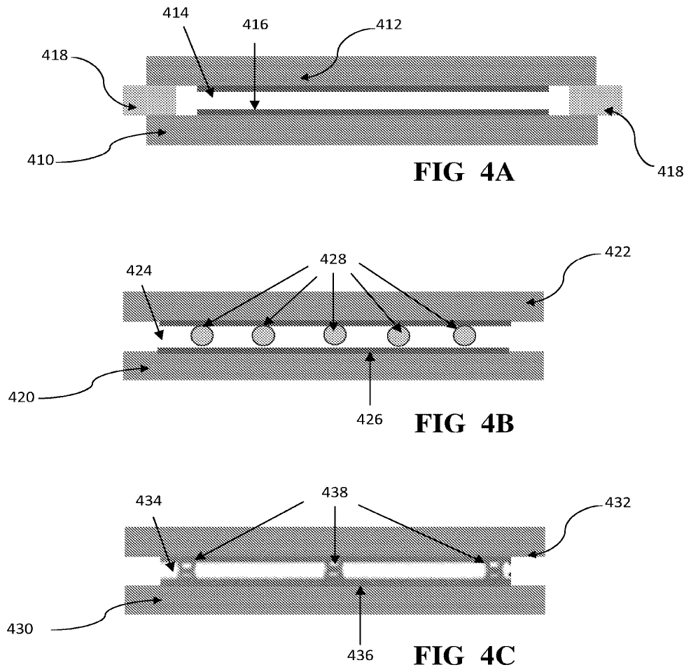

At least one of the first substrate 11 and the second substrate 12 includes an electrode array defined therein. For example and without limitation, and as embodied herein, the first substrate 11 can include a plurality of electrodes positioned on the upper surface of the first substrate 11 to define the electrode array. The electrode array, for example and without limitation electrode arrays 200 or 400 shown in FIGS. 3-4B and discussed further herein, is configured to generate electrical actuation forces to urge at least one droplet along the at least one of the first substrate 11 and second substrate 12, as discussed further herein. Although the plurality of electrodes 17 are depicted in the first substrate 11, devices in accordance with the disclosed subject matter can have electrodes in either the first substrate 11, the second substrate 12, or in both of the first and second substrates.

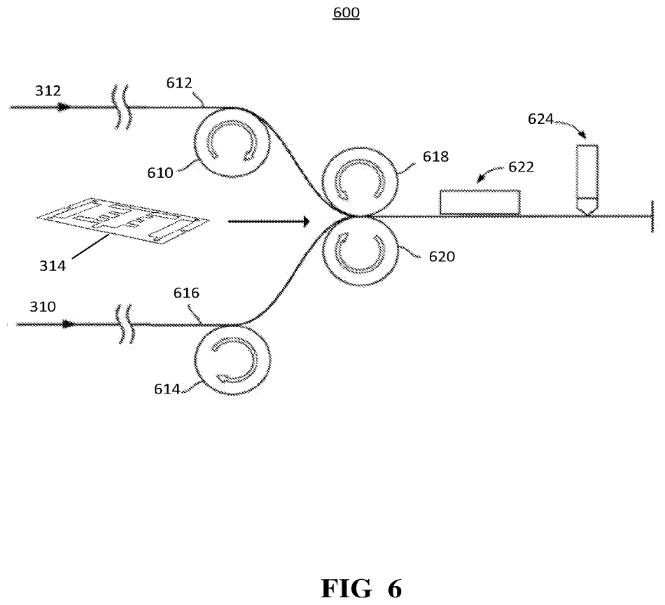

Referring still to FIG. 1A, the device 10 can include a first portion 15, where liquid droplet, such as, a sample droplet, reagent droplet, etc., can be introduced onto at least one of the first substrate 11 and second substrate 12. The device 10 can include a second portion 16, towards which a liquid droplet can be urged. The first portion 15 can also be referred to as the sample preparation module and the second portion 16 can be referred to as the analyte detection module. For example, liquid can be introduced into the gap 13 via a droplet actuator (not illustrated). Alternatively, liquid can be into the gap via a fluid inlet, port, or channel. As discussed further herein, for example with respect to FIG. 6, the device 10 can include chambers for holding sample, wash buffers, binding members, enzyme substrates, waste fluid, etc. Assay reagents can be contained in external reservoirs as part of the integrated device, where predetermined volumes can be urged from the reservoir to the device surface when needed for specific assay steps. Additionally, assay reagents can be deposited on the device in the form of dried, printed, or lyophilized reagents, where they can be stored for extended periods of time without loss of activity. Such dried, printed, or lyophilized reagents can be rehydrated prior or during analyte analysis.

With further reference to FIG. 1A, a layer 18 of dielectric/hydrophobic material can be disposed on the upper surface of the first substrate. For example and not limitation, and as embodied herein, Teflon can be used as both the dielectric and hydrophobic material. However, any suitable material having dielectric and hydrophobic properties can be used, as described further herein. The layer 18 can cover the plurality of electrodes 17 in the electrode array. Alternatively, and shown for example in the exemplary device depicted in FIG. 1B, a layer 38 of dielectric material can be disposed on the upper surface of the first substrate and covering the plurality of electrodes 17 of the electrode array. A layer 34 of hydrophobic material can be overlaid on the dielectric layer 38. In this manner, any suitable combination of materials having dielectric and hydrophobic properties can be used to form layer 38 and layer 34, respectively, as described further herein.

At least one of the first substrate 11 and the second substrate 12 has a well array 19. For example and without limitation, and with reference to FIG. 1A, the well array 19 can be positioned in the layer 18 of the first substrate 11 in the second portion 16 of the device. With reference to FIG. 1B, the well array 19 can alternatively be positioned in the layer 34. While reference is made herein to the well array 19 in the first substrate 11, the well array 19 can be positioned on either the first substrate 11, the second substrate 12, or on both of the first and second substrates. As embodied herein, the plurality of electrodes 17 and the well array 19 can be defined in the same one of the first substrate or the second substrate. Alternatively, the plurality of electrodes 17 and the well array 19 can be defined in different substrates.

The first and second substrates can be made from a flexible material, such as paper (with ink jet-printed electrodes) or polymers, such as PET, PMMA, COP, COC, and PC. Alternatively, the first and second substrates can be made from a non-flexible material, such as for example, printed circuit board, plastic or glass or silicon. For purpose of illustration and not limitation, as embodied herein, one or both of the substrates can be made from a single sheet, which can undergo subsequent processing to create the plurality of electrodes. As embodied herein, one or more sets of the plurality of electrodes can be fabricated on a substrate which can be cut to form a plurality of substrates overlaid with a plurality of electrodes. For example and not limitation, the electrodes can be bonded to the surface of the conducting layer via a general adhesive agent or solder.

The electrodes can be comprised of a metal, metal mixture or alloy, metal-semiconductor mixture or alloy, or a conductive polymer. Some examples of metal electrodes include copper, gold, indium, tin, indium tin oxide, and aluminum. For example, the dielectric layer comprises an insulating material, which has a low electrical conductivity or is capable of sustaining a static electrical field. For example, the dielectric layer can be made of porcelain (e.g., a ceramic), polymer or a plastic. The hydrophobic layer can be made of a material having hydrophobic properties, such as, for example, Teflon and generic fluorocarbons. In another example, the hydrophobic material can be a fluorosurfactant (e.g., FluoroPel). In embodiments including a hydrophilic layer deposited on the dielectric layer, the hydrophilic layer can be a layer of glass, quartz, silica, metallic hydroxide, or mica.

The plurality of electrodes can include a certain number of electrodes per unit area of the first substrate, which number can be increased or decreased based on size of the electrodes and a presence or absence of inter-digitated electrodes. Electrodes can be fabricated using a variety of processes including, photolithography, atomic layer deposition, laser scribing or etching, laser ablation, flexographic printing and ink-jet printing of electrodes. For example and not limitation, a special mask pattern can be applied to a conductive layer disposed on an upper surface of the first substrate followed by laser ablation of the exposed conductive layer to produce a plurality of electrodes on the first substrate.

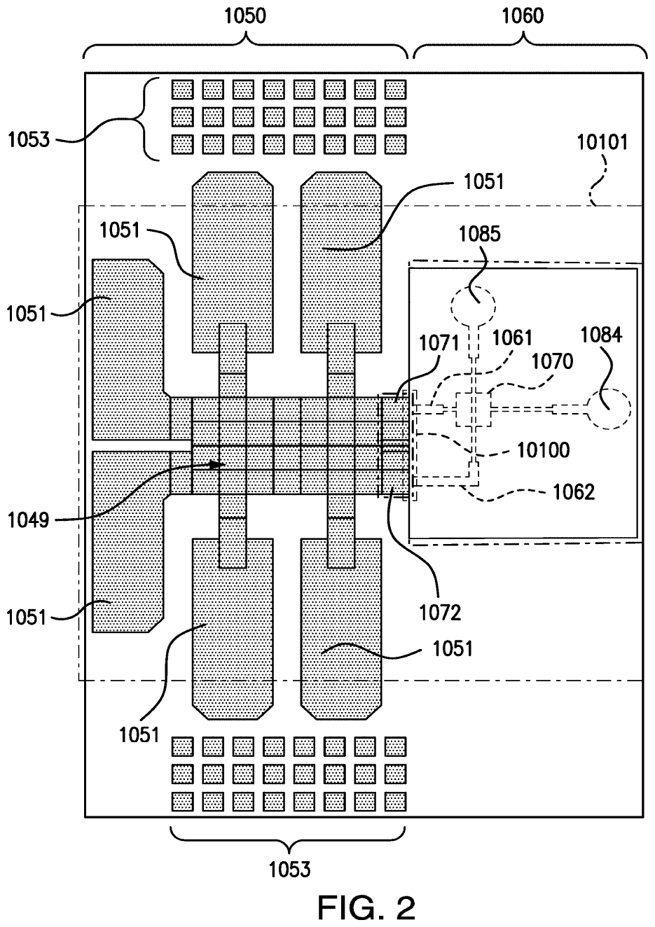

FIG. 2 is a plan view of an exemplary embodiment of an integrated digital microfluidic and analyte detection device in accordance with the disclosed subject matter. The digital microfluidics module is depicted with a plurality of electrodes forming an array of electrodes 1049 that are operatively connected to a plurality of reservoirs 1051. The plurality of reservoirs 1051 can be used for generation of droplets, as described herein, to be transported to an analyte detection module 1060. For example, one or more of the reservoirs 1051 can contain a reagent or a sample. Different reagents can be present in different reservoirs. Also depicted in the microfluidics module 1050 are contact pads 1053 that connect the array of electrodes 1049 to a power source (not shown). Trace lines connecting the array of electrodes 1049 to the contact pads are not depicted. The array of electrodes 1049 can transport one or more droplets, for example and not limitation, a buffer droplet or a droplet containing a buffer and/or a tag (such as and without limitation, a cleaved tag or dissociated aptamer) to the analyte detection module 1060. The analyte detection module 1060 can be any module for detecting analytes, for example and not limitation, a single-molecule detection module, such as a nanowell module or a nanopore module. Additional details and examples of analyte detection modules for use with the disclosed subject matter are described in U.S. Patent Application Publication No. 2018/0095067, which is incorporated by reference herein in its entirety.

For example and as embodied herein, the electrical potential generated by the plurality of electrodes urge liquid droplets, formed on an upper surface of the first layer (or the second layer when present) covering the plurality of electrodes, across the surface of the digital microfluidic device to be received by the well array. In this manner, each electrode can independently urge the droplets across the surface of the digital microfluidic device.

FIG. 3 illustrates an exemplary integrated digital microfluidic and analyte detection device 300 with a spacer in accordance with the disclosed subject matter. As shown for example in FIG. 3, for purpose of illustration and not limitation, device 300 includes first substrate 310, second substrate 312, and spacer 314. The first substrate 310 and the second substrate 312 are aligned substantially parallel to each other with a gap in between for the placement of the spacer 314.

The first substrate 310 includes first electrode array 320, second electrode array 322, and third electrode array 324. The second electrode array 322 is spaced apart from, and in electrical communication with, the first electrode array 320. The third electrode array 324 is also spaced apart from, and in electrical communication with, the first electrode array 320. In addition, an interstitial space 326 is located on the first substrate 310 between the first electrode array 320 and the second electrode array 322, and an interstitial space 328 is located on the first substrate 310 between the first electrode array 320 and the third electrode array 324.

For purpose of example, at least one of the first electrode array 320 and the second electrode array 322 can be configured to form an external electrical connection. As embodied herein, the second electrode array 322 and the third electrode array 324 can each be configured to form an external electrical connection. For purpose of example, and as embodied herein, the second electrode array 322 and third electrode array 324 can define contact pads for making an external electrical connection. As embodied herein, the external electrical connection can be made between the contact pads of the second electrode array 322 and the third electrode array 324 and pogo pins. The second electrode array 322 and the third electrode array 324 can be in electrical communication with the first electrode array 320, and can transmit electrical energy from the pogo pins to the first electrode array 320 to generate electrical actuation forces within the actuation area.

Referring still to FIG. 3, the first electrode array 320 is located proximate a center of the first substrate 310 and the second electrode array 322 and the third electrode array 324 is located proximate a perimeter of, and spaced from the center of, the first substrate 310. The third electrode array 324 is located on an opposite side of the device 300 from the second electrode array 322, with the first electrode array 324 located between the third electrode array 324 and the second electrode array 322. The first substrate 310 and second substrate 320 can each comprise at least one of PET, PMMA, COP, COC, and PC, or any other suitable materials. In addition, the width of each of the first substrate 310 and the second substrate 320 can be between approximately 100 pm and approximately 500 μm.

The first substrate 310 also includes apertures 330, 332, 334, 336 disposed proximate corners of the first substrate 310. For purpose of illustration and not limitation, apertures 330, 332, 334, 336 can be configured as alignment apertures, for example to align the first substrate 310 with the spacer 314 and the second substrate 312 and receive a fastener therethrough. As embodied herein, at least one of the first electrode array 320, the second electrode array 322, or the third electrode array 324 is configured to generate electrical actuation forces to urge one or more liquid droplets along the space between the first substrate 310 and the second substrate 320 within an actuation region defined by at least one of the first electrode array 320, the second electrode array 322, or the third electrode array 324.

With continued reference to FIG. 3, spacer 314 is disposed proximate the interstitial space 326 between the first electrode array 320 and the second electrode array 322 and the interstitial space 328 between the first electrode array 320 and the third electrode array 324. The spacer 314 can include a first opening 340, a second opening 342, and a third opening 344, each or any of which can extend through the surface of the spacer 314. As embodied herein, the first opening 340 is aligned with the first electrode array 320 in plan view, the second opening 342 is aligned with the second electrode array 322 in plan view, and the third opening 344 is aligned with the third electrode array 324 in plan view. The first opening 340, second opening 342, and third opening 344 are shaped to avoid interference with the electrical connections between the first electrode array 320, second electrode array 322, and third electrode array 324.

As shown for example in FIG. 3, for purpose of illustration and not limitation, the spacer 314 includes apertures 350, 352, 354, 356 disposed proximate corners of the spacer 314, and the second substrate 312 includes apertures 360, 362, 364, 366 disposed proximate corners of the second substrate 312. Apertures 360, 362, 364, 366 can be configured as alignment apertures, for example to align and fasten the spacer 314 in between the first substrate 310 (using apertures 330, 332, 334, 336) and the second substrate 312 and receive a fastener therethrough.

FIGS. 4A-4C each illustrate an exemplary embodiment of an integrated digital microfluidic and analyte detection device with an alternative spacer configuration in accordance with the disclosed subject matter. FIG. 4A illustrates an exemplary embodiment of an integrated digital microfluidic and analyte detection device having a spacer configured as a shim. As shown for example in FIG. 4A, an integrated digital microfluidic and analyte detection device includes a first substrate 410 and a second substrate 412, where the second substrate 412 is aligned generally parallel to the first substrate 410 with a gap 414 therebetween. The second substrate 412 can be positioned over the first substrate 410, or alternatively, the second substrate 412 can be positioned below the first substrate 410 (not shown). In addition, an electrode array 416 can be disposed on the upper surface of the first substrate 410. As shown for example in FIG. 4A, one or more spacers 418 can be placed at one or more locations in the gap 414 at the perimeter of the first and second substrates 410, 412. As embodied herein, the one or more spacers 418 can be one or more shims. The spacers 418 can be positioned to extend beyond the perimeter of the first and second substrates 410, 412, or alternatively, the spacers 418 can be positioned to substantially align with the perimeter of the first and second substrates 410, 412. In addition, or as a further alternative, the spacers 418 can be positioned to avoid contact with the electrode array 416.

FIG. 4B illustrates another exemplary embodiment of an integrated digital microfluidic and analyte detection device having a spacer configured as at least one bead. As shown for example in FIG. 4B, the integrated digital microfluidic and analyte detection device includes a first substrate 420 and a second substrate 422, where the second substrate 422 is aligned generally parallel to the first substrate 410 with a gap 424 therebetween. The device of FIG. 4B can have the second substrate 422 positioned over the first substrate 420, and an electrode array 426 can be disposed on the upper surface of the first substrate 420. As shown for example in FIG. 4B, one or more spacers 428 can be placed at one or more locations in the gap 424 between the first and second substrates 420, 422. As embodied herein, the one or more spacers 428 can be one or more beads, which as embodied herein, can have a spherical shape. The spacers 428 can be positioned proximate a plurality of positions within the area of the electrode array 426, such as without limitation, proximate the perimeter, proximate the center, and/or between the perimeter and center. For example and not limitation, and as embodied herein, the spacers 428 can be disposed within the area of the electrode array 426 and spaced equidistant from each other spacer 428, or alternatively, can be spaced different distances from each other spacer 428. In addition, or as a further alternative, the spacers 428 can be positioned in contact the electrode array 426.

FIG. 4C illustrates another exemplary embodiment of an integrated digital microfluidic and analyte detection device having a spacer configured as raised features fabricated on at least one of the substrates. As shown for example in FIG. 4C, the integrated digital microfluidic and analyte detection device includes a first substrate 430 and a second substrate 432, where the second substrate 432 is aligned generally parallel to the first substrate 430 with a gap 434 therebetween. The device of FIG. 4C can have the second substrate 432 positioned over the first substrate 430, and an electrode array 436 can be disposed on the upper surface of the first substrate 430. As shown for example in FIG. 4C, one or more spacers 438 can be placed at one or more locations in the gap 434 between the first and second substrates 430, 432. As embodied herein, the one or more spacers 438 can be one or more raised features. For example and not limitation, as embodied herein, the spacers can be raised features fabricated on one or both of the first substrate 430 and second substrate 432, such as and without limitation by printing, embossing, or any other suitable technique. The spacers 438 can be positioned proximate a plurality of positions within the area of the electrode array 436, such as without limitation, proximate the perimeter, proximate the center, and/or between the perimeter and center. For example and not limitation, and as embodied herein, the spacers 438 can be disposed within the area of the electrode array 436 and spaced equidistant from each other spacer 438, or alternatively, can be spaced different distances from each other spacer 438. In addition, or as a further alternative, the spacers 438 can be positioned in contact the electrode array 436.

In accordance with another aspect of the disclosed subject matter, a method of making a digital microfluidic device is provided. The method includes forming a first electrode array and a second electrode array with a first interstitial area therebetween on at least one of a first substrate and a second substrate, at least one of the first electrode array and the second electrode array configured to generate electrical actuation forces within an actuation area to urge at least one droplet along the at least one of the first substrate and the second substrate within a gap defined between the first and second substrates in side view. The method further includes joining the first substrate and the second substrate proximate opposing sides of at least one spacer to form a chip assembly, the at least one spacer disposed in the first interstitial area to maintain the gap between the first substrate and the second substrate. The digital microfluidic device can be formed including any features or combination of features described herein.

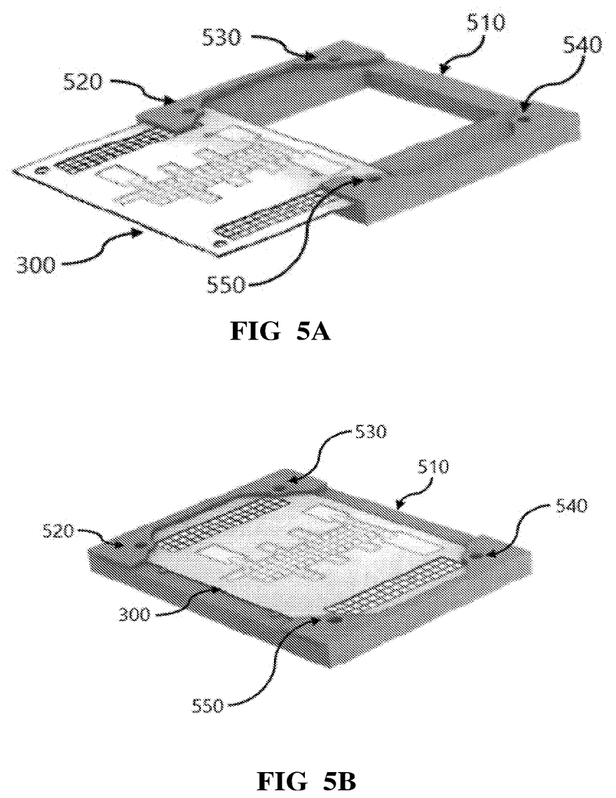

FIGS. 5A and 5B illustrate exemplary integrated digital microfluidic and analyte detection device inserted into and disposed within a frame 510 in accordance with the disclosed subject matter. As shown for example in FIG. 5A, and with reference to FIG. 3, for purpose of illustration and not limitation, and as embodied herein, the device 300, including the first substrate 310, the second substrate 312, and the spacer 314 disposed therebetween, is received and aligned by the frame 510. The frame 510 has apertures 520, 530, 540, 550 disposed proximate corners of the frame 510.

Referring now to FIG. 5B, for purpose of illustration and not limitation, and as embodied herein, the apertures 520, 530, 540, 550 of the frame 510 can be aligned with the corresponding apertures 330, 332, 334, 336 of the first substrate 310, apertures 360, 362, 364, 366 of the second substrate 312, and apertures 350, 352, 354, 356 of the spacer 314. In this manner, as embodied herein, a fastener (not shown) can be received through each of the apertures 520, 530, 540, 550 of the frame 510 to maintain alignment of and apply tension to the aligned first substrate 310, spacer 314, and second substrate 312, and to hold the configuration taut. For purpose of illustration and not limitation, as embodied herein, the fastener can be a clip, a rod, clamp, screw, or any other suitable fastener.

Referring again to FIG. 3, when the first substrate 310, spacer 314, and the second substrate 312 are fastened, the spacer 314 is disposed between the first substrate 310 and the second substrate 312 proximate at least a first contact point 380 and a second contact point 382. The first contact point 380 can be spaced from the second contact point 382 by a distance within a range of approximately 1 mm to approximately 60 mm.

The first substrate 310 can be spaced from the second substrate 312 at the first contact point 380 by a first height, and the first substrate 310 can be spaced from the second substrate 312 at a midpoint of the span between the first contact point 380 and the second contact point 382 by a second height with a fluid droplet, where the difference between the first height and the second height can define a deflection amount of the first substrate 310 relative the second substrate 312. The deflection amount can be within a range of approximately 0.05 μm and approximately 180 μm when a liquid droplet is located proximate the midpoint.

The spacer can be made from a flexible or non-flexible material. As embodied herein, the spacer 314 can include at least one of PET, PMMA, glass, and silicon. Additionally, or alternatively, the spacer can include adhesive on one side or on both sides. For purpose of example, the spacer can include double-sided tape. The spacer 314 can have a width between approximately 100 μm and approximately 200 μm.

Additionally or alternatively, and as embodied herein, the integrated devices for performing analyte analysis can be formed, for example and without limitation, using the materials and techniques described in U.S. Patent Application Publication No. 2018/0095067, which is incorporated by reference herein in its entirety. As discussed above, the first substrate 310 and second substrate 320 can comprise at least one of PET, PMMA, COP, COC, and PC, or any other suitable materials. In addition, the spacer 314 can comprise at least one of PET, PMMA, glass, silicon, and double-sided tape.

For purpose of illustration and not limitation, as embodied herein, FIG. 6 illustrates an exemplary method 600 of assembling the integrated digital microfluidic and analyte detection device with a spacer. The method 600 includes a first roller 610 moving along a first path 612 for feeding a continuous strip of the first substrate 310 (e.g., merged portions of the first substrate) and a second roller 614 moving along a second path 616 for feeding a continuous strip of the second substrate 312 (e.g., merged portions of the second substrate). The first roller 610 and the second roller 612 feed into a pair of merging rollers 618, 620 such that as each of the merging rollers 618, 620 rotates, the first substrate 310 and the second substrate 312 are aligned in a parallel configuration at a predetermined spaced apart distance with a gap between them for the placement of the spacer 316. As embodied herein, As shown for example in FIG. 3, the apertures 330, 332, 334, 336 of the first substrate 310, the apertures 350, 352, 354, 356 of the spacer 314, and the apertures 360, 362, 364, 366 of the second substrate 312 can be used as alignment apertures to align and fasten the spacer 314 in between the first substrate 310 and the second substrate 312.

As the first substrate 310 and the second substrate 312 are aligned in the parallel configuration with the gap in between, the spacer 314 is placed in the gap between the first substrate 310 and the second substrate 312, and then the aligned first substrate 310 and second substrate 312, along with the spacer 314 positioned in between them, are moved to a bonding station 622. The bonding station 622 joins, or bonds, the first substrate 310 to the second substrate 312 with the spacer 314 in between them as part of fabricating the individual integrated devices. For example, at the bonding station 622, one or more adhesives can be selectively applied to a predefined portion of first substrate 310 and/or the second substrate 312 (e.g., a portion of the first substrate 310 and/or the second substrate 312 defining a perimeter of the resulting integrated device) to create a bond between the first substrate 310 and the second substrate 312 while preserving the gap between them based the positioning of the spacer 314 between the first substrate 310 and the second substrate 312.

After the bonding station 622, the integrated devices can be selectively cut, diced or otherwise separated to form one or more separate integrated digital microfluidic and analyte detection devices by dicing station 624. The dicing station 624 can be, for example, a cutting device, a splitter, or more generally, an instrument to divide the continuous merged portions of the first substrate 310 and the second substrate 312 into discrete units corresponding to individual integrated devices. As an example, the merged portions can be cut into individual integrated devices based on, for example, the electrode pattern such that each integrated device includes a footprint of the electrode array and the other electrodes that are formed via the electrode pattern (As shown for example in FIG. 3).

For purpose of understanding and not limitation, various operational characteristics achieved by the devices and techniques disclosed herein are provided. As described herein, the first substrate and/or the second substrate can deflect or deform in certain areas, for example proximate the center of device and/or other areas spaced apart from the edges of the substrates, due at least in part to the weight of the substrates and/or to surface tension from the liquid droplets. The devices described herein include at least one spacer disposed in the gap separating the first and second substrates to reduce or minimize deflection and/or deformation of the first and second substrates.

In the following examples, samples of devices 300 having first and second substrates formed from PET film having different thicknesses and joined to form contact points defining spans of different distances were produced and tested by measuring deflection of the first substrate toward the second substrate at the midpoint of the span with a droplet disposed proximate the midpoint. For purpose of comparison and confirmation of the disclosed subject matter, two control devices with substrates of different thicknesses and having no contact points, thus forming a span of 60 mm, were measured having a deflection of 136 um at the midpoint for substrates having a thickness of 125 um, and a deflection of 30 um at the midpoint for substrates having a thickness of 30 um.

By comparison, samples of devices 300 were formed having contact points defining a span of 6 mm and were measured having a deflection of 0.44 um at the midpoint for substrates having a thickness of 125 um, and a deflection of 0.057 um at the midpoint for substrates having a thickness of 250 um. Samples of devices 300 were formed having contact points defining a span of 10 mm and were measured having a deflection of 1.42 um at the midpoint for substrates having a thickness of 125 um, and a deflection of 0.18 um at the midpoint for substrates having a thickness of 250 um.

In accordance with another aspect of the disclosed subject matter, a digital microfluidic and analyte detection device is provided. The device generally includes a first substrate and a second substrate aligned generally parallel to each other with a gap defined therebetween in side view. At least one of the first substrate and the second substrate has a first electrode array, a second electrode array spaced from and in electrical communication with the first array, and a first interstitial area defined between the first electrode array and the second electrode array. An analyte detection device is defined in at least one of the first substrate and the second substrate, and at least one of the first electrode array and the second electrode array is configured to generate electrical actuation forces within an actuation area to urge at least one droplet within the gap along the at least one of the first substrate and the second substrate to the analyte detection device. At least one spacer is disposed in the first interstitial area to maintain the gap between the first substrate and the second substrate. The digital microfluidic device and analyte detection device can include any features or combination of features described herein.

For purpose of illustration and not limitation, and as embodied herein, the digital microfluidic devices described herein can be configured as a sample preparation module combined with an analyte detection module to form a digital microfluidic and analyte detection device, for example and without limitation as described in U.S. Patent Application Publication No. 2018/0095067, which is incorporated by reference herein in its entirety.

As embodied herein, the sample preparation module can be used for performing steps of an immunoassay. Any immunoassay format can be used to generate a detectable signal which signal is indicative of presence of an analyte of interest in a sample and is proportional to the amount of the analyte in the sample.

For purpose of illustration and not limitation, and as embodied herein, the detection module includes the well array that are optically interrogated to measure a signal related to the amount of analyte present in the sample. The well array can have sub-femtoliter volume, femtoliter volume, sub-nanoliter volume, nanoliter volume, sub-microliter volume, or microliter volume. For example, the well array can be array of femtoliter wells, array of nanoliter wells, or array of microliter wells. As embodied herein, the wells in an array can all have substantially the same volume. The well array can have a volume up to 100 μl, e.g., about 0.1 femtoliter, 1 femtoliter, 10 femtoliter, 25 femtoliter, 50 femtoliter, 100 femtoliter, 0.1 pL, 1 pL, 10 pL, 25 pL, 50 pL, 100 pL, 0.1 nL, 1 nL, 10 nL, 25 nL, 50 nL, 100 nL, 0.1 microliter, 1 microliter, 10 microliter, 25 microliter, 50 microliter, or 100 microliter.

As embodied herein, and as described herein, the sample preparation module and the detection module can both be present on a single base substrate and both the sample preparation module and the detection module can include a plurality of electrodes for moving liquid droplets. As embodied herein, such a device can include a first substrate and a second substrate, where the second substrate is positioned over the first substrate and separated from the first substrate by a gap. The first substrate can include a first portion (e.g., proximal portion) at which the sample preparation module is located, where a liquid droplet is introduced into the device, and a second portion (e.g., distal portion) towards which the liquid droplet moves, at which second portion the detection module is located. As used herein, “proximal” in view of “distal” and “first” in view of “second” are relative terms and are interchangeable with respect to each other.

The space between the first and second substrates can be up to 1 mm in height, e.g., 0.1 μm, 0.5 μm, 1 μm, 5 μm, 10 μm, 20 μm, 50 μm, 100 μm, 140 μm, 200 μm, 300 μm, 400 μm, 500 μm, 1 μm-500 μm, 100 μm-200 μm, etc. The volume of the droplet generated and moved in the devices described herein can range from about 10 μl to about 5 picol, such as, 10 μl-1 picol, 7.5 μl-10 picol, 5 μl -1 nL, 2.5 μl-10 nL, or 1 μl-100 nL, 800-200 nL, 10 nL-0.5 μl e.g., 10 μl, 1μl, 800 nL, 100 nL, 10 nL, 1 nL, 0.5 nL, 10 picol, or lesser.

As embodied herein, first portion and the second portion are separate or separate and adjacent. As embodied herein, the first portion and the second portion are co-located, comingled or interdigitated. The first substrate can include a plurality of electrodes overlaid on an upper surface of the first substrate and extending from the first portion to the second portion. The first substrate can include a layer disposed on the upper surface of the first substrate, covering the plurality of electrodes, and extending from the first portion to the second portion. The first layer can be made of a material that is a dielectric and a hydrophobic material. Examples of a material that is dielectric and hydrophobic include polytetrafluoroethylene material (e.g., Teflon®) or a fluorosurfactant (e.g., FluoroPel™). The first layer can be deposited in a manner to provide a substantially planar surface. A well array can be positioned in the second portion of the first substrate and overlying a portion of the plurality of electrodes and form the detection module. The well array can be positioned in the first layer. As embodied herein, prior to or after fabrication of the well array in the first layer, a hydrophilic layer can be disposed over the first layer in the second portion of the first substrate to provide a well array that have a hydrophilic surface. The space/gap between the first and second substrates can be filled with air or an immiscible fluid. As embodied herein, the space/gap between the first and second substrates can be filled with air.

As embodied herein, the sample preparation module and the detection module can both be fabricated using a single base substrate but a plurality of electrodes for moving liquid droplets can only be present only in the sample preparation module. As embodied herein, the first substrate can include a plurality of electrodes overlaid on an upper surface of the first substrate at the first portion of the first substrate, where the plurality of electrodes do not extend to the second portion of the first substrate. As embodied herein, the plurality of electrodes are only positioned in the first portion. A first layer of a dielectric/hydrophobic material, as described herein, can be disposed on the upper surface of the first substrate and can cover the plurality of electrodes. As embodied herein, the first layer can be disposed only over a first portion of the first substrate. Alternatively, the first layer can be disposed over the upper surface of the first substrate over the first portion as well as the second portion. A well array can be positioned in the first layer in the second portion of the first substrate, forming the detection module that does not include a plurality of electrodes present under the well array.

As embodied herein, the second substrate can extend over the first and second portions of the first substrate. As embodied herein, the second substrate can be substantially transparent, at least in region overlaying the well array. Alternatively, the second substrate can be disposed in a spaced apart manner over the first portion of the first substrate and cannot be disposed over the second portion of the first substrate. Thus, As embodied herein, the second substrate can be present in the sample preparation module but not in the detection module.

As embodied herein, the second substrate can include a conductive layer that forms an electrode. The conductive layer can be disposed on a lower surface of the second substrate. The conductive layer can be covered by a first layer made of a dielectric/hydrophobic material, as described herein. As embodied herein, the conductive layer can be covered by a dielectric layer. The dielectric layer can be covered by a hydrophobic layer. The conductive layer and any layer(s) covering the conductive layer can be disposed across the lower surface of the second substrate or can only be present on the first portion of the second substrate. As embodied herein, the second substrate can extend over the first and second portions of the first substrate. As embodied herein, the second substrate and any layers disposed thereupon (e.g., conductive layer, dielectric layer, etc.) can be substantially transparent, at least in region overlaying the well array.

As embodied herein, the plurality of electrodes on the first substrate can be configured as co-planar electrodes and the second substrate can be configured without an electrode. The electrodes present in the first layer and/or the second layer can be fabricated from a substantially transparent material, such as indium tin oxide, fluorine doped tin oxide (FTO), doped zinc oxide, and the like.

As embodied herein, the sample preparation module and the detection module can be fabricated on a single base substrate. Alternatively, the sample preparation module and the detection modules can be fabricated on separate substrates that can subsequently be joined to form an integrated microfluidic and analyte detection device. As embodied herein, the first and second substrates can be spaced apart using a spacer that can be positioned between the substrates. The devices described herein can be planar and can have any shape, such as, rectangular or square, rectangular or square with rounded corners, circular, triangular, and the like.

While the disclosed subject matter is described herein in terms of certain preferred embodiments, those skilled in the art will recognize that various modifications and improvements can be made to the disclosed subject matter without departing from the scope thereof. Moreover, although individual features of one embodiment of the disclosed subject matter can be discussed herein or shown in the drawings of the one embodiment and not in other embodiments, it should be apparent that individual features of one embodiment can be combined with one or more features of another embodiment or features from a plurality of embodiments.

In addition to the specific embodiments claimed below, the disclosed subject matter is also directed to other embodiments having any other possible combination of the dependent features claimed below and those disclosed above. As such, the particular features presented in the dependent claims and disclosed above can be combined with each other in other manners within the scope of the disclosed subject matter such that the disclosed subject matter should be recognized as also specifically directed to other embodiments having any other possible combinations. Thus, the foregoing description of specific embodiments of the disclosed subject matter has been presented for purposes of illustration and description. It is not intended to be exhaustive or to limit the disclosed subject matter to those embodiments disclosed.

It will be apparent to those skilled in the art that various modifications and variations can be made in the method and system of the disclosed subject matter without departing from the spirit or scope of the disclosed subject matter. Thus, it is intended that the disclosed subject matter include modifications and variations that are within the scope of the appended claims and their equivalents.

1. A digital microfluidic device, comprising:
a first substrate and a second substrate aligned generally parallel to each other with a gap defined therebetween in side view, at least one of the first substrate and the second substrate including:
a first electrode array,
a second electrode array spaced from and in electrical communication with the first electrode array, and
a first interstitial area defined between the first electrode array and the second electrode array,
at least one of the first electrode array and the second electrode array configured to generate electrical actuation forces within an actuation area to urge at least one droplet within the gap along the at least one of the first substrate and second substrate; and
at least one spacer disposed in the first interstitial area to maintain the gap between the first substrate and the second substrate.

2. The device of claim 1, wherein the first electrode array is disposed proximate a central region of the at least one of the first substrate and the second substrate and the second electrode array is disposed proximate a perimeter region of and spaced from the central region of the at least one of the first substrate and the second substrate.

3. The device of claim 1, wherein the at least one of the first substrate and the second substrate further includes a third electrode array disposed thereon opposite the second electrode array with the first electrode array therebetween and a second interstitial area defined between the first electrode array and the third electrode array, the at least one spacer disposed in the second interstitial area.

4. The device of claim 1, wherein the at least one spacer includes a first opening extending therethrough and aligned with the first electrode array in plan view.

5. The device of claim 4, wherein the at least one spacer includes a second opening extending therethrough and aligned with the second electrode array in plan view.

6. The device of claim 5, wherein the at least one of the first substrate and the second substrate further includes a third electrode array disposed thereon, and the at least one spacer includes a third opening extending through a surface thereof and aligned with the third electrode array in plan view.

7. The device of claim 1, wherein the first substrate, the second substrate, and the at least one spacer each include at least one fastener hole aligned to receive a fastener through corresponding fastener apertures of the first substrate, the second substrate and the at least one spacer.

8. The device of claim 7, wherein the first substrate, the second substrate, and the at least one spacer each include four fastener apertures each disposed proximate corresponding corners of the first substrate, the second substrate and the at least one spacer.

9. The device of claim 1, further comprising a frame configured to receive and align the first substrate, the second substrate and the at least one spacer.

10. The device of claim 7, further comprising a frame configured to receive and align the first substrate, the second substrate and the at least one spacer, the frame having at least one frame fastener hole aligned with at least one of the corresponding fastener apertures of the first substrate, the second substrate and the at least one spacer, to receive the fastener through the at least one frame fastener hole.

11. The device of claim 4, wherein the at least one spacer is disposed between the first substrate and the second substrate at a first contact point and a second contact point, the first contact point spaced a distance along the gap from the second contact point by a span, and wherein the distance is within a range of 1 mm to 60 mm.

12. The device of claim 11, wherein the first substrate is spaced from the second substrate at the first contact point by a first height, and the first substrate is spaced from the second substrate proximate a midpoint of the span by a second height, a difference between the first height and the second height defining a deflection amount, the deflection amount being within a range of 0.05 μm and 180 μm when the at least one droplet is disposed proximate the midpoint.

13. The device of claim 1, wherein the at least one of the first substrate and the second substrate includes a non-conductive layer and a conductive layer coupled to the non-conductive layer, the conductive layer having the electrode array defined therein.

14. The device of claim 1, wherein the at least one of the first substrate and the second substrate includes at least one of a hydrophobic layer and a dielectric layer disposed over the electrode array.

15. The device of claim 1, wherein the electrode array is formed on the at least one of the first substrate and the second substrate using at least one of lithography, laser ablation, and inkjet printing.

16. The device of claim 1, wherein at least one of the first electrode array and the second electrode array is configured to form external electrical connections.

17. The device of claim 1, wherein at least one of the first substrate and the second substrate comprises at least one of an array of wells and a nanopore layer formed therein.

18. The device of claim 1, wherein the spacer comprises at least one of PET, PMMA, glass, silicon, and double-sided tape.

19. The device of claim 1, wherein the spacer has a width between 100 μm and 200 μm.

20. The device of claim 1, wherein the at least one spacer comprises at least one of a shim, a spherical bead, and a raised feature.

21. The device of claim 1, wherein at least one of the first substrate and the second substrate comprises at least one of PET, PMMA, COP, COC, and PC.

22. The device of claim 1, wherein the width of at least one of the first substrate or the second substrate is between 100 μm and 500 μm.

23. A method of making a digital microfluidic device, comprising:
forming a first electrode array and a second electrode array with a first interstitial area therebetween on at least one of a first substrate and a second substrate, at least one of the first electrode array and the second electrode array configured to generate electrical actuation forces within an actuation area to urge at least one droplet along the at least one of the first substrate and the second substrate within a gap defined between the first and second substrates in side view; and
joining the first substrate and the second substrate proximate opposing sides of at least one spacer to form a chip assembly, the at least one spacer disposed in the first interstitial area to maintain the gap between the first substrate and the second substrate.

24. The method of claim 23, further comprising:
disposing the chip assembly within a frame, wherein the first substrate, the second substrate, and the at least one spacer each include at least one fastener hole aligned with corresponding fastener apertures of the others of the first substrate, the second substrate and the at least one spacer, and the frame having at least one frame fastener hole aligned with at least one of the corresponding fastener apertures of the first substrate, the second substrate and the at least one spacer; and
fastening the assembly to the frame by inserting a fastener through each of the at least one frame fastener hole and the corresponding fastener apertures.

25. The method of claim 23, wherein forming the first and second electrode arrays comprises at least one of lithography, laser ablation, and inkjet printing.

26. The method of claim 23, further comprising positioning the first substrate and the second substrate using a plurality of rollers.

27. A digital microfluidic and analyte detection device, comprising:
a first substrate and a second substrate aligned generally parallel to each other with a gap defined therebetween in side view, at least one of the first substrate and the second substrate including:
a first electrode array,
a second electrode array spaced from and in electrical communication with the first electrode array, and
an interstitial area defined between the first electrode array and the second electrode array;
an analyte detection device defined in at least one of the first substrate and the second substrate, wherein at least one of the first electrode array and the second electrode array is configured to generate electrical actuation forces within an actuation area to urge at least one droplet within the gap along the at least one of the first substrate and the second substrate to the analyte detection device; and
at least one spacer disposed in the interstitial area to maintain the gap between the first substrate and the second substrate.
